(19) United States
(12) Patent Application Publication
(10) Pub. No.: US 2015/0040672 A1
(43) Pub. Date: Feb. 12, 2015

(54) METHOD AND APPARATUS FOR REMOTELY MONITORING A WATER HEATER

(71) Applicants: Randall T. Meyer, Garland, TX (US); Michael David Nash, Norman, OK (US); Jonathan Walker Meyer, Garland, TX (US)

(72) Inventors: Randall T. Meyer, Garland, TX (US); Michael David Nash, Norman, OK (US); Jonathan Walker Meyer, Garland, TX (US)

(73) Assignee: NATIONAL WHOLESALE SUPPLY, INC., Dallas, TX (US)

(21) Appl. No.: 13/965,074

(22) Filed: Aug. 12, 2013

(51) Int. Cl. G01L 19/00

(52) U.S. Cl. CPC G01L 19/0092
USPC 73/700

(57) ABSTRACT

A method is provided for monitoring pressure within a water heater. The method comprises: heating water contained within a vessel in the water heater; sensing strain on the vessel; correlating the sensed strain to a pressure within the vessel; and providing an indication in response to the water pressure exceeding a desired pressure.

### BACKGROUND OF THE INVENTION

1. Field of the Invention

This invention relates generally to water heaters, and, more particularly, to a monitoring system for indicating when the operating parameters of a water heater fall outside a desired range.

2. Description of the Related Art

In the field of food preparation, such as at restaurants, cafeterias, grocery stores, or the like, cleaning and sanitizing procedures are precisely defined and strictly enforced to preserve the health and safety of the customers. For example, sanitation is precisely defined in an exemplary food sanitation code as, immersion for at least one-half minute in clean hot water at a temperature of not less than 170 degrees Fahrenheit (76.7 degrees Celsius). Those skilled in the field of food preparation will appreciate that sanitization is an effective bactericidal treatment by heat, which destroys pathogens on surfaces treated. Proper sanitation preserves the health of the public by dramatically reducing the presence of bacteria and pathogens on food preparation equipment, utensils and tableware.

Food sanitation codes commonly specify that the procedure must clean and sanitize the article so as to produce an average plate count of not more than 100 colonies on the surface of the utensils examined, with no coliform bacteria. It will be appreciated, however, that variations in the water temperature can significantly impact the effectiveness of the sanitizing procedure. Even relatively modest variations in water temperature can result in unacceptable contamination of the equipment, utensils and tableware. Generally, food sanitation codes require that the water temperature be manually monitored to insure that it is within acceptable limits. In particular, the food sanitation codes commonly require that a numerically scaled, indicating thermometer accurate to plus or minus two degrees Fahrenheit (1.1 degrees Celsius) be kept at a location convenient to the sink for frequent checks of water temperature. Such a system, of course, relies heavily on the discretion and memory of the dish washer, which may be subject to at least some abuse, particularly during relatively busy periods of time.

Moreover, in some situations, it is possible for the temperature of the water to rise to a level that creates excessive pressure within the water heater tank. Such excessive pressure can lead to premature failure of the water heater tank and/or damage to the water heater itself.

### SUMMARY OF THE INVENTION

In one aspect of the instant invention, a method is provided for monitoring pressure within a vessel suitable for containing water. The method comprises: sensing strain on the vessel; correlating the sensed strain to a pressure within the vessel; and providing an indication in response to the water pressure exceeding a desired pressure.

In another aspect of the instant invention, a method is provided for monitoring pressure within a water heater. The method comprises: heating water contained within a vessel in the water heater; sensing strain on the vessel; correlating the sensed strain to a pressure within the vessel; and providing an indication in response to the water pressure exceeding a desired pressure.

In yet another aspect of the instant invention, a method is provided for monitoring temperature within a vessel suitable for containing water. The method comprises: sensing strain on the vessel; correlating the sensed strain to a temperature within the vessel; and providing an indication in response to the water temperature exceeding a desired temperature.

### BRIEF DESCRIPTION OF THE DRAWINGS

The invention may be understood by reference to the following description taken in conjunction with the accompanying drawings, in which like reference numerals identify like elements, and in which:

FIG. 1 is a stylized diagram of a restaurant employing a temperature monitoring device in accordance with one embodiment of the present invention; and

FIG. 2 depicts a block diagram of one embodiment of an electrical control circuit that may be employed in the temperature monitoring device of FIG. 1;

FIGS. 3A and 3B depict stylized side and end views of one embodiment of a mounting arrangement for a temperature sensor that may be disposed adjacent a water heater and used in the temperature monitoring device of FIGS. 1 and 2; and

FIG. 4 depicts a flow chart of an alternative embodiment of a software based control circuit that may be employed in the temperature monitoring device of FIG. 1.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

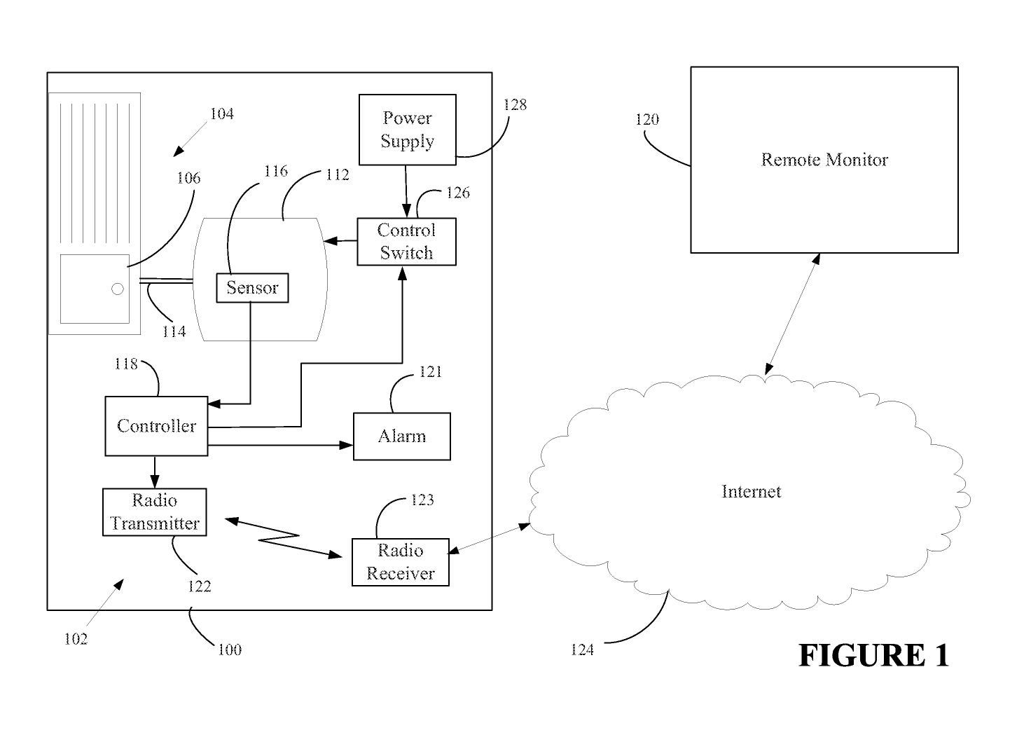

Turning now to the drawings and specifically referring to FIG. 1, a stylistic view of at least a portion of a business 100, such as a conventional restaurant with a water heater monitoring device 102 installed therein is illustrated. The restaurant includes a kitchen with a dishwashing area 104. The dishwashing area 104 may be comprised of a sink 106 and a faucet fixture (not shown) or an automatic dishwasher (not shown). A water heater or boiler 112 is hydraulically coupled to the faucet fixture via a water line 114 so as to provide heated water into the sink 106 for immersing and washing the utensils and tableware used in the preparation and service of the restaurant fare.

The water heater monitoring device 102 includes a sensor 116 coupled to a vessel that contains water to be heated, such as the water heater 112, a tank within the water heater 112, or the water line 114 extending therefrom. The sensor 116 is configured and calibrated to provide an electrical signal that has at least one characteristic related to the temperature of water supplied from the water heater 112 and/or the pressure within the water heater 112. For example, the sensor 116 may be configured to provide a voltage signal that varies in relation to a strain or stress experienced by the water heater 112 or the water line 114, which may be correlated to the pressure within the tank and the temperature of the water. Similarly, the sensor 116 may also produce a current that varies with stress or strain. Those skilled in the art will appreciate that variations in the voltage and/or current of the sensor 116 may be affected by variations in the properties of material located within the sensor 116. Those skilled in the art will appreciate that any of a variety of conventional strain or stress sensors 116 may be employed without departing from the spirit and scope of the instant invention. In one embodiment, the stress sensor may take the form of a strain gauge, such as a device commercially available from Omega as part number SGD-10/350-LY13. Those skilled in the art will appreciate that the sensor 116 may take on any of a variety of forms.

The sensor 116 is electrically coupled to a controller 118. Generally, the controller 118 is responsible for monitoring certain identified parameters of the water heater 112, collecting such information and providing the information to a remote monitor 120. Additionally, the controller 118 may collect information regarding the instant temperature, a maximum temperature, a minimum temperature, the instant pressure, a maximum pressure, and a minimum pressure and may identify certain characteristics, such as the water temperature or pressure rising above a preselected setpoint, falling below a preselected setpoint, or both. The setpoints may be selected to provide indications when the water temperature or pressure has fallen below a level needed for adequate sanitization, or has risen above a level that may be considered safe.

The water heater monitoring device 102 may include an alarm 121 that may take any of a wide variety of forms, including an audible alarm, a visual alarm, or a combination thereof. The alarm 121 may be configured to visually flash and/or audibly beep in a manner to attract attention. In one embodiment of the instant invention, it may be useful to locate the alarm 121 in the dishwashing area 104 so as to immediately alert the dishwasher that the temperature of the water has fallen too low, or the temperature or pressure is too high. Alternatively, the alarm 121 or a secondary alarm (not shown) may be located adjacent a manager's office, so that the manager may be alerted to promptly contact the manufacturer or a maintenance company to indicate that the water heater 112 is in need of service. The alarm 121 may even be equipped to provide a contact telephone number of the maintenance company, visually or audibly.

Communications between the controller 118 and the remote monitor 120 may take any of a variety of forms. In one embodiment, the controller 118 may be coupled to a radio transmitter 122 that communicates to a remotely located radio receiver 123. The radio transmitter 122 and the radio receiver 123 may operate according to any of a variety of conventional standards, including, but not limited to, WiFi (e.g., 802.11(a), (b), (g), (n), (p) or the like), bluetooth, etc. The radio receiver 123 may be coupled to the remote monitor 120 via a network connection, such as the Internet 124, so that information collected by the controller may be delivered to the remote monitor 120.

The remote monitor 120 may be constructed and positioned at a convenient location, such as at the offices of a business that sells the water heater monitoring device 102 along with a monitoring service. The monitoring service may include a variety of features, including dispatching a repair service in the event that the controller 118 communicates information to the remote monitor 120 that indicates that a problem exists. Additionally, the remote monitor 120 may also be configured to send information and control signals to the controller 118 via the connection through the Internet 124, the radio receiver 123 and the radio transmitter 122. Based on the information received from the remote monitor 120, the controller 118 may modify its behavior. For example, the remote monitor 120 can send information to the controller 118 that causes the controller 118 to alter the rate at which the temperatures are being measured. For example, should problematic operation of the water heater 112 be detected, the remote monitor 120 may instruct the controller 118 to increase the rate at which temperature measurements are being made. Those skilled in the art will appreciate that the operation of the water heater 112 may be diagnosed more accurately from a remote location if temperature or pressure measurements are being taken at a higher rate. During normal operation, the rate at which temperature or pressure measurements are being taken may be substantially reduced.

The remote monitor 120 may also be used to send a disconnect signal to the controller 118 to take the water heater 112 off line in response to detecting faulty or undesirable behavior of the water heater 112. The water heater 112 may be taken off line by temporarily interrupting electrical power being delivered to the water heater 112. In one embodiment, the controller 118 is coupled to a control switch 126 that is positioned intermediate a source of power, such as a power supply 128 and the water heater 112. Thus, the controller 118 may act to cause the control switch 126 to open and remove electrical power from the water heater 112. The controller 118 may act to remove electrical power removed from the water heater 112 under various scenarios, for example, if the controller 118 or the remote monitor 120 determines that the water temperature or the pressure is too high or too low, the controller 118 may independently act, or may be instructed to act by the remote monitor 120, to open the control switch 126. In one embodiment, the control switch 126 may take the form of a conventional relay, such as is available from OMRON as part number G5V-2-H1-DC5. In some instances, it may be desirable to use a control switch 126 that is normally open, so that should the controller 118 or remote monitor 120 fail, no signal will be deliver to the control switch 126 and it will open and remove power from the water heater 112. Those skilled in the art will appreciate that the instant invention may have applicability to a wide variety of conventional water heating devices. Some conventional water heating devices include an electrical heating element that may be controllably energized to heat the water or controllably de-energized to cease heating the water. In this type of conventional water heating device, the control switch may be used to interrupt the flow of electrical current to the electrical heating element either directly or indirectly.

Other conventional water heating devices include a burner element that heats the water in the vessel by burning a flammable gas or liquid, such as natural gas or propane. In this type of conventional water heating device, the control switch 126 may be arranged to control the operation of a valve that will interrupt the flow of flammable gas to the burner element, so as to interrupt heating of the water within the vessel.

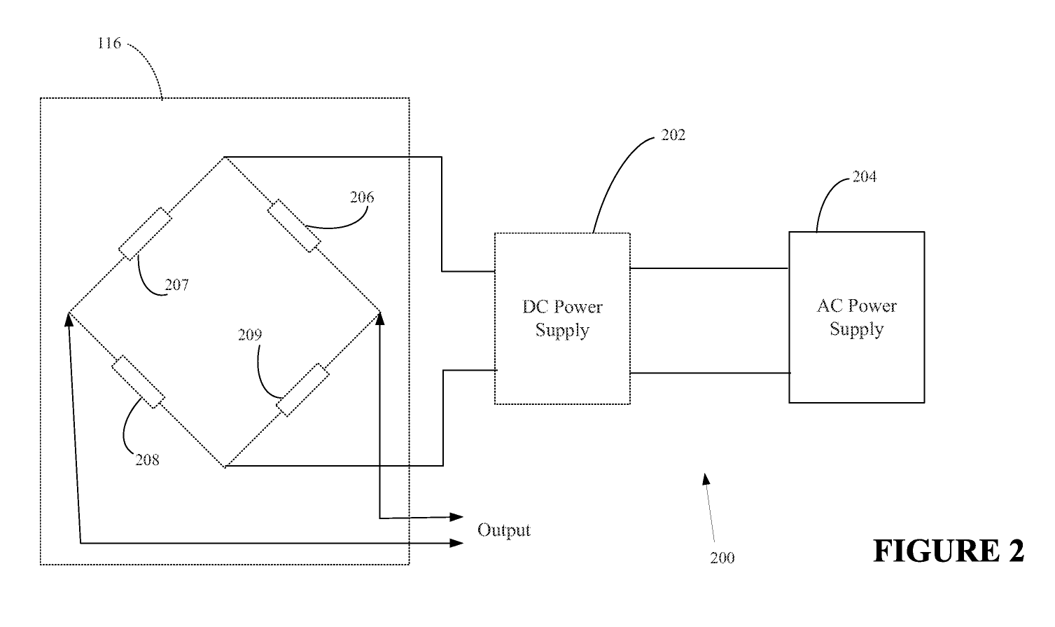

Turning now to FIG. 2, a circuit diagram of one embodiment of the sensor 116 is shown. A power supply 200 is arranged to supply voltage and current to the sensor 116. Those skilled in the art will appreciate that any of a variety of power supplies may be used without departing from the spirit and scope of the instant invention. In the illustrated embodiment the power supply 200 takes the form of a direct current (DC) power supply 202, which may be coupled to a conventional 110V alternating current (AC) source 204. One exemplary power supply that may be used in the instant invention is manufactured by Shortage Control Inc. as part no. BT-24-40.

The power supply 202 has a first and second terminal coupled to a first and second terminal of the sensor 116. In the illustrated embodiment, the sensor 116 takes the form of a conventional strain gauge that is formed by a set of four resistors 206-209 coupled in a Wheatstone bridge arrangement. The sensor 116 includes a pair of output terminals 210 that are coupled to the controller 118. As discussed above, any of a variety of sensors may be employed. Those skilled in the art will appreciate that the sensor 116 may be affixed to an outer surface of the water heater 112, such as on an exterior surface of a water tank or water line within the water heater 112. As the water in the tank or water line is heated, the pressure inside the tank or water line increases, creating a strain on the tank or water line, which produces a corresponding strain on the strain gauge coupled to the tank or water line. The output from the strain gauge may be correlated to the actual pressure within the tank or water line, and the actual pressure may be further correlated to the actual temperature of the water within the tank or water line. The relationship between the detected strain and the actual water temperature or pressure may be recorded in a look-up table stored in memory in the controller 118. The controller 118 uses the output signal from the sensor 116 to access the look-up table and determine the corresponding temperature or pressure of the water within the water heater 112. The look-up table may be created at the time of manufacture based on a known relationship between strain gauge output and temperature or pressure, or alternatively may be created during an initialization procedure where the strain gauge output is correlated to actual measured temperatures of the water or the pressure in the water heater 112.

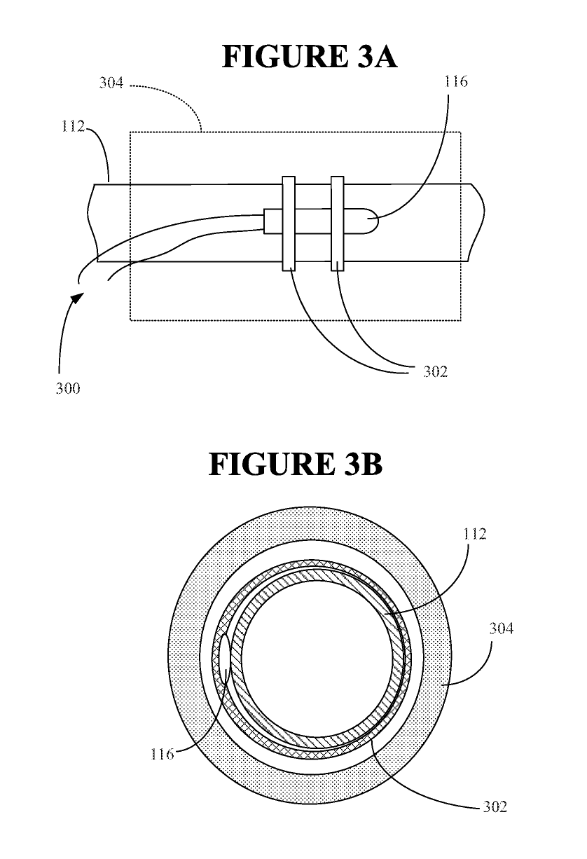

Referring now to FIGS. 3A and 3B, a stylized side and cross sectional end view of a mounting arrangement of the sensor 116 on the water heater 112 is shown. The sensor 116 is mounted adjacent the water heater 112 in close mechanical contact therewith. Mounting of the sensor 116 may be accomplished mechanically, chemically or by integral formation therewith. In the illustrated embodiment, the sensor 116 is coupled to the water heater by a one or more fasteners shown stylistically as elements 302. The fasteners 302 should provide sufficient force to urge the temperature sensor 114 into close and secure contact with the water heater 112 so that stress or strain induced in the water heater 112 by heating of the water within the water heater 112 is readily transferred from the water heater 112 to the sensor 116. In this way, the stress experience by the sensor 116 is closely related to the temperature of the water located therein. Those skilled in the art will appreciate that electrically conductive lines 300 extend from the sensor 116 and may be coupled to the controller 118 and power supply 200, as shown in FIGS. 1 and 2.

In some applications of the instant invention, it may be useful to provide a layer of insulation 304 around the water line 110 to reduce the likelihood that exterior air temperature will impact the temperature detected by the sensor 116. The insulation 304 may take the form of conventional semi-rigid foam insulation, and may be affixed to the water heater 112 by any of a variety of techniques. For example, the insulation 304 may be affixed to the water heater 112 by friction, tape, glue, mechanical fasteners, and the like. In one embodiment of the instant invention, the insulation 304 is affixed to the water heater 112 by ties (not shown).

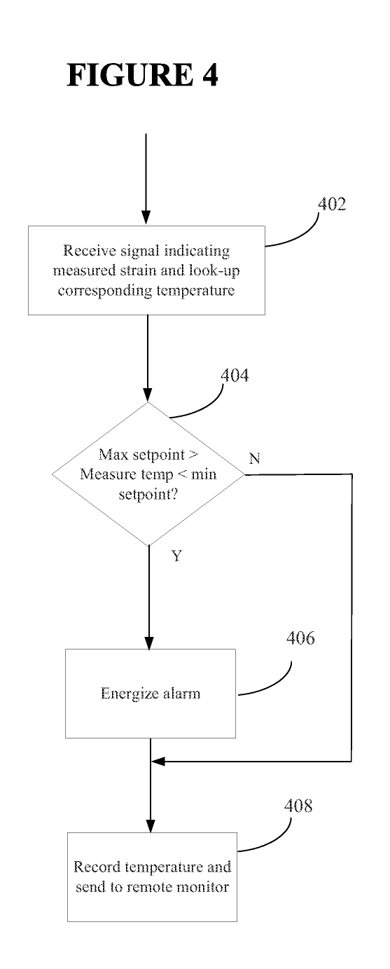

Those skilled in the art will appreciate that the operation of the controller 118 may be accomplished by a data processing device, such as a microprocessor (not shown), operating under software control. Referring now to FIG. 4, a flowchart describing one embodiment of a method that may be implemented in the software operating on the microprocessor is shown.

Unless specifically stated otherwise, or as is apparent from the discussion, terms such as “processing” or “computing” or “calculating” or “determining” or “displaying” or the like, refer to the action and processes of a data processing system, or similar electronic computing device, that manipulates and transforms data represented as physical, electronic quantities within the computer system's registers and memories into other data similarly represented as physical quantities within the computer system's memories or registers or other such information storage, transmission or display devices.

The process begins at block 402, where the microprocessor receives a signal from the sensor 116 and accesses a look-up table to correlate the received signal with the temperature or pressure of the water in the water heater 112. The signal includes a parameter, such as current, voltage, frequency, or the like, that is related to the strain currently being experienced by the water heater 112. At decision block 404, the microprocessor compares the measured temperature to a minimum desired temperature, such as a temperature needed to achieve sanitary cleansing and to a maximum desired temperature. If the measured temperature is greater than the minimum setpoint and the measure pressure is below a maximum setpoint, then the temperature of the water is at a desired level and the alarm does not need to be energized and no action needs to be taken to take the water heater 112 offline. On the other hand, if the measured temperature is less than the sanitary setpoint or the measured pressure is greater than the maximum setpoint, then a fault has occurred and control transfers to block 406 where the alarm is energized to alert restaurant personnel of the fault. Thereafter, the controller 118 records the determined temperature or pressure and reports the temperature and/or pressure to the remote monitor 120.

The principles of the instant invention may find application in other areas that would benefit from monitoring a pressure within a vessel. For example, in the field of air conditioning, the sensor 116 may be affixed to a vessel containing refrigerant, such that the pressure of the refrigerant within the vessel may be monitored by detecting strain experienced by the vessel in a manner substantially similar to that discussed herein with respect to a water heater. In an AC system, the monitored pressure may be used to control the operation of the air conditioner, such as by discontinuing the operation of the air conditioner system in response to the monitored pressure being above or below a desired limit. The operation of the air conditioner may be discontinued in a manner similar to that discussed herein with respect to a water heater, such as by interrupting the flow of electricity to the air conditioner by opening the contacts of a relay. Alternatively, a controller may be used to normally send an activation signal to the compressor of the air conditioning system, and when the pressure within the vessel is detected as being too high or too low, the controller may cease to send the activation signal to the compressor.

Those skilled in the art will appreciate that the microprocessor may be configured to provide audible spoken alarms, indicating that the water temperature is too low. Moreover, the spoken alarm may also provide a contact telephone number for the manufacturer or maintenance group. In this way, the proper personnel may be quickly and easily notified of the fault so that it may be promptly corrected.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method for monitoring pressure within a vessel suitable for containing water, comprising:
sensing strain on the vessel;
correlating the sensed strain to a pressure within the vessel; and
providing an indication in response to the water pressure exceeding a desired pressure.

2. A method, as set forth in claim 1, wherein strain is sensed using a strain gauge coupled to the vessel.

3. A method, as set forth in claim 1, wherein strain is sensed using a wheatstone bridge coupled to the vessel.

4. A method, as set forth in claim 1, further comprising, heating the water contained in the vessel, and wherein providing an indication in response to the water pressure exceeding the desired pressure further comprises discontinuing the heating of the water in response to the pressure exceeding the desired pressure.

5. A method, as set forth in claim 4, wherein discontinuing the heating of the water in response to the pressure exceeding the desired pressure further comprises disconnecting a water heater element from a source of electric power.

6. A method, as set forth in claim 4, wherein discontinuing the heating of the water in response to the pressure exceeding the desired pressure further comprises interrupting a flow of a flammable liquid or gas to a heating element associated with the vessel.

7. A method, as set forth in claim 1, wherein correlating the sensed strain to a pressure within the vessel further comprises accessing a lookup table that correlates the sensed strain to a pressure within the vessel.

8. A method for monitoring pressure within a water heater, comprising:
heating water contained within a vessel in the water heater;
sensing strain on the vessel;
correlating the sensed strain to a pressure within the vessel; and
providing an indication in response to the water pressure exceeding a desired pressure.

9. A method, as set forth in claim 8, wherein strain is sensed using a strain gauge coupled to the vessel.

10. A method, as set forth in claim 8, wherein strain is sensed using a wheatstone bridge coupled to the vessel.

11. A method, as set forth in claim 8, further comprising providing an indication in response to the water pressure exceeding the desired pressure further comprises discontinuing the heating of the water in response to the pressure exceeding the desired pressure.

12. A method, as set forth in claim 11, wherein discontinuing the heating of the water in response to the pressure exceeding the desired pressure further comprises disconnecting a water heater element from a source of electric power.

13. A method, as set forth in claim 11, wherein discontinuing the heating of the water in response to the pressure exceeding the desired pressure further comprises interrupting a flow of a flammable liquid or gas to a heating element associated with the vessel.

14. A method, as set forth in claim 8, wherein correlating the sensed strain to a pressure within the vessel further comprises accessing a lookup table that correlates the sensed strain to a pressure within the vessel.

15. A method for monitoring temperature within a water heater, comprising:
heating water contained within a vessel in the water heater;
sensing strain on the vessel;
correlating the sensed strain to a temperature within the vessel; and
providing an indication in response to the water temperature exceeding a desired temperature.

16. A method, as set forth in claim 15, wherein strain is sensed using a strain gauge coupled to the vessel.

17. A method, as set forth in claim 15, wherein strain is sensed using a wheatstone bridge coupled to the vessel.

18. A method, as set forth in claim 15, further comprising providing an indication in response to the water temperature exceeding the desired temperature further comprises discontinuing the heating of the water in response to the temperature exceeding the desired temperature.

19. A method, as set forth in claim 18, wherein discontinuing the heating of the water in response to the temperature exceeding the desired temperature further comprises disconnecting a water heater element from a source of electric power.

20. A method, as set forth in claim 18, wherein discontinuing the heating of the water in response to the temperature exceeding the desired temperature further comprises interrupting a flow of a flammable liquid or gas to a heating element associated with the vessel.

21. A method, as set forth in claim 15, wherein correlating the sensed strain to a temperature within the vessel further comprises accessing a lookup table that correlates the sensed strain to a temperature within the vessel.
